(19) United States
(12) Patent Application Publication
(10) Pub. No.: US 2009/0134155 A1
(43) Pub. Date: May 28, 2009

(54) VENT GRILLE OF MICROWAVE OVEN

(76) Inventors: Won Tae KIM, Seoul (KR); Jong Sik KIM, Seoul (KR); Sung Bae SONG, Seoul (KR)

Correspondence Address: BIRCH STEWART KOLASCH & BIRCH, PO BOX 747, FALLS CHURCH, VA, 22040-0747, US

(21) Appl. No.: 12/258,116

(22) Filed: Oct. 24, 2008

(30) Foreign Application Priority Data
Nov. 28, 2007 (KR) 10-2007-0122197

(51) Int. Cl. H05B 6/64

(52) U.S. Cl. 219/757

(57) ABSTRACT

A vent grille is provided. The vent grille is disposed on a front side of a microwave oven. Exhaust and inlet holes are disposed in a top side of the vent grille. The exhaust and inlet holes are not exposed when viewed from the front of the microwave oven. Air flows into and out of the microwave oven through the inlet and exhaust holes. An oblique guide surface or guide rib is provided to guide air discharged through the exhaust holes. Therefore, the frontal aesthetics of the microwave oven can be improved, and any safety hazard can be prevented. Furthermore, contaminants generated from food can be efficiently removed.

### CROSS-REFERENCE TO RELATED APPLICATIONS

The present application claims priority under 35 U.S.C. §119 and 35 U.S.C. §365 to Korean Patent Application No. 10-2007-0122197 filed on Nov. 28, 2007, which is hereby incorporated by reference in its entirety.

### BACKGROUND

The present invention relates to a microwave oven, and more particularly, to a vent grille configured to guide air into and out of a microwave oven.

Microwave ovens are kitchen appliances used to cook food using microwaves and/or heat. Some microwave ovens (ventilation hooded microwave ovens) are designed to function as a hood as well as a cooking stove The ventilation hooded microwave oven is installed above a gas range or cooking stove for sucking air and contaminants, such as smoke, fumes, and fat generated while food is cooked on the gas range or the cooking stove. The sucked air and contaminants are discharged from the ventilation hooded microwave oven to the outdoor area or back to the indoor area after the contaminants are removed from the air.

The ventilation hooded microwave oven includes a vent grille. Air flows into and out of the ventilation hooded microwave oven through the vent grille. The vent grille is disposed on a front side of the ventilation hooded microwave oven, and air holes are formed in a front side of the vent grille. After contaminants are removed from air introduced into the ventilation hooded microwave oven, the air is discharged back to the indoor area through the air holes or the outdoor area through a duct connected to the ventilation hooded microwave oven.

However, the vent grille of the related art has particular disadvantages.

In the case where the air holes are formed in the front side of the vent grille, the front side of the ventilation hooded microwave oven may have a bad aesthetical appearance due to the air holes.

Furthermore, a user can be burned by hot air discharged from the air holes if the installed location of the ventilation hooded microwave oven is not sufficiently high.

### SUMMARY

Embodiments of the present invention provide a vent grille configured to improve the frontal aesthetics of a microwave oven.

Embodiments of the present invention also provide a vent grille configured to protect users from safety hazards.

Embodiments of the present invention also provide a vent grille configured to decrease contamination.

In one embodiment, a vent grille includes: a grille main body on a front side of a microwave oven; and an air hole disposed in a portion of the grille main body and not exposed when viewed from the front side of the microwave oven, the air hole allowing airflows into and from the microwave oven.

In another embodiment, a vent grille includes: a grille main body on a front side of a microwave oven; an air hole disposed in at least a portion of a top or bottom surface of the grille main body so as to allow airflows into and from the microwave oven; and a guide member configured to allow air to be discharged from the microwave oven through the air hole in a forward direction from the microwave oven.

In a further embodiment, a vent grille includes: a grille main body on a front side of a microwave oven; an air path disposed in the grille main body to allow airflows into and from the microwave oven; and a guide member configured to allow air to be discharged from the microwave oven through the air path in a forward direction from the microwave oven.

The details of one or more embodiments are set forth in the accompanying drawings and the description below. Other features will be apparent from the description and drawings, and from the claims.

### BRIEF DESCRIPTION OF THE DRAWINGS

FIG. 1 is an exploded perspective view illustrating a microwave oven including a vent grille according to a first embodiment.

FIG. 2 is a cross-sectional view illustrating the vent grille according to the first embodiment.

FIG. 3 is a cross-sectional view illustrating a vent grille according to a second embodiment.

FIG. 4 is a cross-sectional view illustrating a vent grille according to a third embodiment.

FIG. 5 is a simulation view illustrating an exemplary flow of air at the vent grille according to the third embodiment.

### DETAILED DESCRIPTION OF THE EMBODIMENTS

A vent grille will now be described in detail with reference to the accompanying drawings according to a first embodiment.

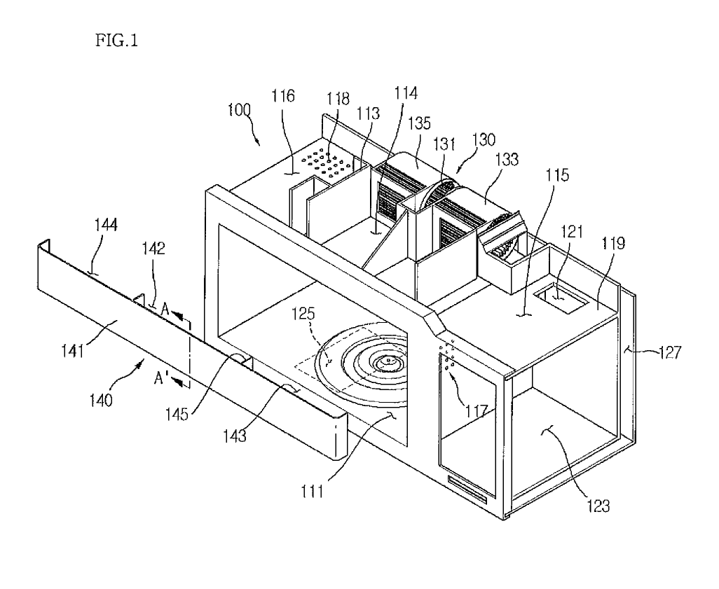

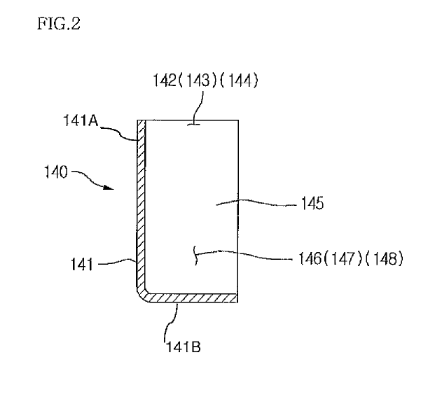

FIG. 1 is an exploded perspective view illustrating a microwave oven 100 including a vent grille 140 according to a first embodiment, and FIG. 2 is a cross-sectional view illustrating the vent grille 140 according to the first embodiment.

Referring to FIG. 1, the microwave oven 100 may be a ventilation hooded microwave oven. The microwave oven 100 includes a cavity forming a cooking chamber 111. Food (not shown) may be placed in the cooking chamber 111 for cooking. In the current embodiment, the cooking chamber 111 is located in the left side of the cavity as shown in FIG. 1.

An air duct 113 is disposed on an upper center portion of the cavity. In other words, the air duct 113 is disposed on an upper portion of the cooking chamber 111. The air duct 113 forms a first exhaust hood path 114 through which air introduced into the microwave oven 100 is discharged to an indoor area. The rear side of the air duct 113 is spaced a predetermined distance apart from a rear inner surface of the cavity. A filter (not shown) may be disposed at a front end portion of the air duct 113. The filter removes contaminants from air flowing through the air duct 113.

A second cooling suction path 115 is formed on a top surface of the cavity at the right side of the air duct 113. A first cooling exhaust path 116 is formed on the top surface of the cavity at the left side of the air duct 113.

A plurality of suction holes 117 are formed in a right wall of the cooking chamber 111. Discharge holes 118 are formed in a top rear surface of the cooking chamber Ill and are connected to the first cooling exhaust path 116. Air can be introduced into the cooking chamber 111 through the suction holes 117. Air can be discharged from the cooking chamber 111 through the discharge holes 118 together with contaminants produced from food (not shown) cooked in the cooking chamber 111.

A compartment plate 119 is disposed at an upper side of the cavity. The compartment plate 119 is located at the right side of the air duct 113. The compartment plate 119 has the same height as the upper side of the cavity. The compartment plate 119 separates the second cooling suction path 115 and an electric component room 123. A connection hole 121 is formed through the compartment plate 119. Air can flow from the second cooling suction path 115 to the electric component room 123 through the connection hole 121.

The electric component room 123 is disposed in the cavity at the right side of the cooking chamber 111. Electric components (not shown) are disposed in the electric component room 123 for generating microwaves. A cooling fan (not shown) is installed in the electric component room 123. The cooling fan forces air to flow in the electric component room 123 to cool the electric components and circulate into the cooking chamber 111. In detail, when the cooling fan operates, air is introduced into the electric component room 123 through an inlet hole 143 (described later) and the second cooling suction path 115 for cooling the electric components disposed in the electric component room 123. Then, some of the air flows from the electric component room 123 into the cooking chamber 111 through the suction holes 117 and is discharged from the cooking chamber 111 to the first cooling exhaust path 116 through the discharge holes 118. Thereafter, the air flows from the first cooling exhaust path 116 to a second exhaust hole 144 where the air is discharged from the microwave oven 100.

A hood inlet 125 is disposed in a bottom surface of the microwave oven 100. Air containing contaminants generated from food cooked on a cooking appliance (not shown) placed under the microwave oven 100 is introduced into the microwave oven 100 through the hood inlet 125. A hood inlet path 127 is formed from the hood inlet 125 to a rear side of the microwave oven 100. The hood inlet path 127 is a path for air and contaminants introduced into the microwave oven 100 through the hood inlet 125.

A vent fan assembly 130 is installed on a top rear portion of the cavity behind the air duct 113. The vent fan assembly 130 forces air to flow into and out of the microwave oven 100. In detail, the vent fan assembly 130 includes a fan motor 131 and a two vent fans 133 and 135 disposed at both sides of the fan motor 131. The fan motor 131 drives the vent fans 133 and 135. The vent fans 133 and 135 force air to flow into the microwave oven 100, and after contaminants are removed from the air, the vent fans 133 and 135 force the air to flow out of the microwave oven 100. In the current embodiment, suction holes of the vent fans 133 and 135 are connected to the hood inlet path 127. Discharge holes of the vent fans 133 and 135 are connected to the first exhaust hood path 114. A duct (not shown) can be connected to a top surface or a rear surface of the microwave oven 100 for discharging air from the microwave oven 100 to an outdoor area. In this ease, the discharge holes of the vent fans 133 and 135 may be connected to the duct.

The vent grille 140 is installed on a front upper portion of the cavity. When the cooling fan operates, the vent grille 140 guides air into the microwave oven 100, and when the vent fan assembly 130 operates, the vent grille 140 guides air from the microwave oven 100 to an outdoor area. Referring to FIGS. 1 and 2, the vent grille 140 includes a grille main body 141 having a front wall 141A and a bottom wall 141B, a first exhaust hole 142, the inlet hole 143, the second exhaust hole 144, and barrier ribs 145. The front wall 141A is fixed (i.e. non-movable) with respect to the bottom wall 141B.

The grille main body 141 has a length corresponding to the width of the cooking chamber 111. The grille main body 141 has a flat hexahedral shape. The grille main body 141 has an opened rear side coupled to a front upper portion of the microwave over 100.

Air flows into and out of the microwave oven 100 through the first exhaust hole 142, the inlet hole 143, and the second exhaust hole 144. The first exhaust hole 142, the inlet hole 143, and the second exhaust hole 144 are formed through a top surface of the grille main body 141 and are not exposed when viewed from the front of the microwave oven 100. In detail, the first exhaust hole 142 is disposed at a center portion of the top surface of the grille main body 141. The inlet hole 143 is disposed at a right portion of the top surface of the grille main body 141. The second exhaust hole 144 is disposed at a left portion of the top surface of the grille main body 141.

In the current embodiment, each of the first exhaust hole 142, the inlet hole 143, and the second exhaust hole 144 may function as an inlet and an outlet according to the direction of air streams generated by the cooling fan or the vent fan assembly 130. The whole top portion of the grille main body 141 is substantially opened to form the first exhaust hole 142, the inlet hole 143, and the second exhaust hole 144.

The number of the barrier ribs 145 may be two. The barrier ribs 145 divide the inner region of the grille main body 141 into three sections. The three sections are connected to the first exhaust hole 142, the inlet hole 143, and the second exhaust hole 144, respectively, for allowing flows of air. For this, the barrier ribs 145 are disposed on an inner surface of the grille main body 141. The barrier ribs 145 may extend along the entire height of the grille main body 141 to form three distinct openings at the top of the grille main body 141, or the barrier ribs 145 may extend only partially upward along the height of the grille main body to form a single, common opening at the top of the grille main body 141.

Hereinafter, one of the three sections connected to the first exhaust hole 142 will be referred to as a second exhaust hood path 146, and another of the three sections connected to the inlet hole 143 will be referred to as a first cooling inlet path 147. The other of the three sections connected to the second exhaust hole 144 will be referred to as a second cooling exhaust path 148. A rear end of the second exhaust hood path 146 is connected to the first exhaust hood path 114. A rear end of the first cooling inlet path 147 is connected to the second cooling suction path 115. A rear end of the second cooling exhaust path 148 is connected to the first cooling exhaust path 116.

An exemplary operation of the vent grille 140 will now be described according to the first embodiment.

When the microwave oven 100 is powered on, electric components such as a magnetron generate microwaves toward the cooking chamber 111. Thus, food placed in the cooking chamber 111 can be heated by the microwaves.

Meanwhile, when the microwave oven 100 is powered on, the cooling fan operates to suck air through the inlet hole 143 of the vent grille 140. The air sucked through the inlet hole 143 flows along the first cooling inlet path 147 and the second cooling suction path 115. Then, the air flows into the electric component room 123 through the connection hole 121. Some of the air introduced into the electric component room 123 flows to the cooking chamber 111 through the suction holes 117. In the cooking chamber 111, the air mixes with contaminants generated from the food cooked in the cooking chamber 111. Then, the air is discharged from the cooking chamber 111 through the discharge holes 118. The air discharged from the cooking chamber 111 flows along the first cooling exhaust path 116 and the second cooling exhaust path 148 and is discharged from the microwave oven 100 to an indoor area through the second exhaust hole 144 of the vent grille 140.

If food is cooked on a cooking stove or other cooking appliance placed under the microwave oven 100, the vent fan assembly 130 operates. Therefore, air and contaminants generated from the food cooked on the cooker are introduced into the microwave oven 100 through the hood inlet 125. Then, the air and contaminants flow along the hood inlet path 127 toward the suction holes of the vent fans 133 and 135. Thereafter, the air and the contaminants are introduced into the vent fans 133 and 135 through the suction holes and are discharged from the vent fans 133 and 135 through discharge holes of the vent fans 133 and 135. Thereafter, the air and the contaminants flow along the first exhaust hood path 114 and the second exhaust hood path 146. While the air and the contaminants flow along the first exhaust hood path 114 and the second exhaust hood path 146, the contaminants may be removed from the air by a filter. Then, the air is discharged from the microwave oven 100 through the first exhaust hole 142 of the vent grille 140 to the indoor area.

The first exhaust hole 142, the inlet hole 143, and the second exhaust hole 144 are not exposed when viewed from the front of the microwave oven 100. Therefore, the frontal aesthetics of the microwave oven 100 can be improved.

Although hot air is discharged from the first exhaust hole 142 and the second exhaust hole 144, the possibility of injuring people standing in front of the microwave oven 100 is low since the hot air is discharged upward from the first exhaust hole 142 and the second exhaust hole 144.

A vent grille will now be described in detail with reference to the accompanying drawing according to a second embodiment.

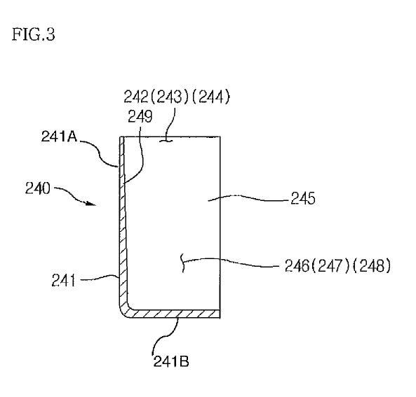

FIG. 3 is a cross-sectional view illustrating a vent grille 240 according to a second embodiment. In the following description of the second embodiment, the same elements as those of the first embodiment will be denoted by the same reference numerals.

Referring to FIG. 3, in the second embodiment, the vent grille 240 includes a grille main body having a front wall 241A and a bottom wall 241B, a first exhaust hole 242, an inlet hole 243, a second exhaust hole 244, and barrier ribs 245. The front wall 241A is fixed (i.e. non-movable) with respect to the bottom wall 241B. The grille main body 241 includes a second exhaust hood path 246, a first cooling inlet path 247, and a second cooling exhaust path 248. That is, the vent grille 240 of the second embodiment has a structure similar to that of the vent grille 140 of the first embodiment. In the second embodiment, the grille main body 241 further includes an oblique guide surface 249 so that air can be discharged through the first exhaust hole 242 and the second exhaust hole 244 at a forwardly-directed angle from the upper side of the microwave oven 100.

In detail, the oblique guide surface 249 is sloped forwardly as it goes upward. In one embodiment, the oblique guide surface 249 is formed by decreasing the thickness of the front wall 241A of the grille main body 241 in the front direction. Therefore, air is discharged through the first exhaust hole 242 and the second exhaust hole 244 at a forwardly directed angle from the upper side of the microwave oven 100. In this case, cabinetry (not shown) in which the microwave oven 100 is installed may not be contaminated by the air discharged from the first exhaust hole 242 and the second exhaust hole 244.

In the second embodiment, the oblique guide surface 249 is formed in regions of the grille main body 141 corresponding to all of the first exhaust hole 242, the inlet hole 243, and the second exhaust hole 244. Alternatively, the oblique guide surface 249 may be formed in regions corresponding to only the first exhaust hole 242 and the second exhaust hole 244. If the vent grille 240 is formed by injection molding, the oblique guide surface 249 may be formed in the entire inner surface of the front wall 241A of the grille main body 241 for all of the first exhaust hole 242, the inlet hole 243, and the second exhaust hole 244.

A vent grille will now be described in detail with reference to the accompanying drawing according to a third embodiment.

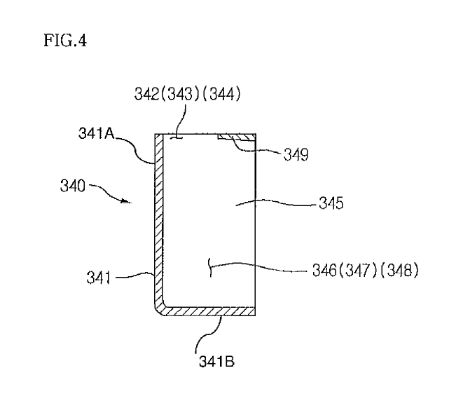

FIG. 4 is a cross-sectional view illustrating a vent grille 340 according to a third embodiment. In the following description of the third embodiment, the same elements as those of the first and second embodiments will be denoted by the same reference numerals.

Referring to FIG. 4, the vent grille 340 of the third embodiment includes a guide rib 349. That is, the vent grille 340 includes the guide rib 349 in addition to a grille main body 341 having a front wall 341A and a bottom wall 341B, a first exhaust hole 342, an inlet hole 343, a second exhaust hole 344, and barrier ribs 345. The front wall 341A is fixed (i.e. non-movable) with respect to the bottom wall 341B. Owing to the guide rib 349, air can be discharged through first and second exhaust holes 342 and 344 at a forwardly-directed angle from the upper side of the microwave oven 100. The guide rib 349 is disposed at a top rear edge portion of the grille main body 341 and extends toward the first exhaust hole 342, the inlet hole 343, and the second exhaust hole 344. A front edge of the guide rib 349 is spaced a predetermined distance away from an upper edge of the front wall of 341A of the grille main body 341. That is, the first exhaust hole 342, the inlet hole 343, and the second exhaust hole 344 are disposed between the front edge of the guide rib 349 and the upper edge of the front wall 341A of the grille main body 341. The sizes of the first exhaust hole 342, the inlet hole 343, and the second exhaust hole 344 are smaller than the cross-sectional areas of a second exhaust hood path 346, a first cooling inlet path 347, and a second cooling exhaust path 348, respectively.

The guide rib 349 may be tapered forwardly. The guide rib 349 may be formed at portions of the top rear edge portion of the grille main body 341 corresponding to only the first and second exhaust holes 342 and 344, or may be formed at the entire top rear edge portion of the grille main body 341.

An exemplary airflow through the vent grille 340 will now be described according to the third embodiment.

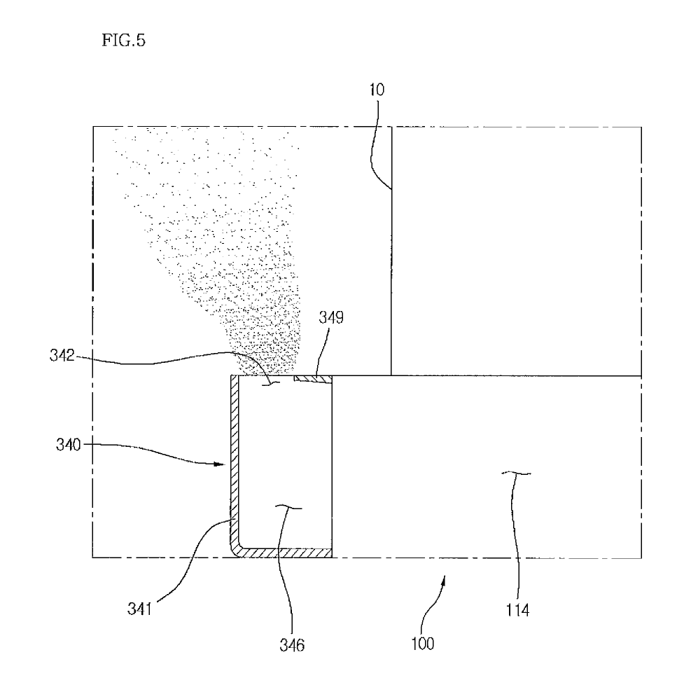

FIG. 5 is a simulation view illustrating an exemplary airflow through the vent grille 340 according to the third embodiment.

Referring to FIG. 5, when the vent fan assembly 130 (refer to FIG. 1) operates, air flows along the first exhaust hood path 114, and contaminants are removed from the air by a filter. Then, the air flows into the second exhaust hood path 346. Thereafter, the air is discharged from the second exhaust hood path 346 to an indoor area through the first exhaust hole 342. When the air is discharged through the first exhaust hole 342, the guide rib 349 guides the air forwardly. Therefore, the air discharged through the first exhaust hole 342 may not reach cabinetry 10 in which the microwave oven 100 is installed. Accordingly, the cabinetry 10 may be not contaminated by the air discharged through the first exhaust hole 342.

As described above, the use of the vent grille may improve the frontal aesthetics of the microwave oven and decrease the possibility of safety hazards. Furthermore, contamination may be decreased.

In detail, the vent grille provides the following effects.

Since air holes such as the exhaust and inlet holes are disposed in the top or bottom surface of the vent grille, the front surface of the vent grille can be shaped or finished like the front surface of the microwave oven so that the microwave oven can have an aesthetically good appearance.

Furthermore, since air is discharged upward from the microwave oven through the air holes, users can be protected from the air, which is usually hot.

In addition, the air holes extend to a front edge portion of the top or bottom surface of the vent grille, and a guide member such as the oblique guide surface or the guide rib is provided to guide air discharged through the air holes in a forward direction of the microwave oven. Therefore, when air is discharged through the air holes, the air does not interfere with the front edge portion of the top or bottom surface of the vent grille. As a result, the microwave oven, and/or kitchen walls or cabinets where the microwave oven is installed can be prevented from being contaminated by the air discharged through the air holes.

Although embodiments have been described with reference to a number of illustrative embodiments thereof, it should be understood that numerous other modifications and embodiments can be devised by those skilled in the art that will fall within the spirit and scope of the principles of this disclosure. More particularly, variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

For examples in the above-described embodiments the exhaust holes and the inlet hole are disposed in the top surface of the grille main body. However, the spirit and scope of the principles of this disclosure are not limited thereto. For example, if the vent grille is coupled to a front lower portion of the microwave oven, the exhaust holes and the inlet hole may be disposed in a bottom surface of the grille main body.

In addition, the vent grille can include both the oblique guide surface 249 and the guide rib 349. In this case, air discharged through the exhaust holes of the vent grille may be guided forwardly from the front side of the microwave oven more effectively.

Finally, although the present invention has been described in the context of a microwave oven having a vent hood, it should be evident that the described vent grille may be used with an ordinary microwave oven not including a vent hood.

What is claimed is:

1. A vent grille comprising:
a grille main body locatable on a front side of a microwave oven, the grille main body having a fixed front wall free of any airflow openings; and
at least one air outlet disposed in a portion of the grille main body and not visible when viewed from the front side of the microwave oven, the air outlet allowing airflow out of the microwave oven.

2. The vent grille according to claim 1, further comprising a guide member configured to allow air to be discharged from the microwave oven through the air outlet in a direction away from cabinetry in which the microwave oven is installed.

3. The vent grille according to claim 1, further comprising a guide member configured to allow air to be discharged through the air outlet in a forward direction from the microwave oven.

4. The vent grille according to claim 1, wherein the air outlet extends at least to a front edge portion of a top or bottom surface of the grille main body.

5. The vent grille according to claim 1, wherein the air outlet comprises:
at least one exhaust hole disposed in a portion of a top or bottom surface of the grille main body; and
an inlet hole disposed in another portion of the top or bottom surface of the grille main body close to the exhaust hole.

6. The vent grille according to claim 5, wherein air and contaminants generated from food cooked on a cooking appliance disposed under the microwave oven are introduced into the microwave oven and are discharged to an indoor area through the exhaust hole after the contaminants are removed from the air.

7. The vent grille according to claim 5, wherein air and contaminants generated from food cooked in a cooking chamber of the microwave oven are discharged from the microwave oven through the exhaust hole.

8. The vent grille according to claim 5, wherein air is introduced into the microwave oven through the inlet hole to cool electric components of the microwave oven and is then discharged from the microwave oven through the exhaust hole.

9. The vent grille according to claim 2, wherein the guide member is a guide rib disposed at a rear side of the air outlet close to the front side of the microwave oven.

10. The vent grille according to claim 9, wherein the guide rib is disposed on the other portion of the top or bottom surface of the grille main body except the air outlet.

11. The vent grille according to claim 9, wherein the air outlet is disposed in the top surface of the grille main body, wherein the guide rib guides air to the air outlet in an upwardly sloped direction, and then the air is discharged from the microwave oven through the air outlet.

12. The vent grille according to claim 2, wherein the guide member is a guide rib covering a portion of the air outlet and disposed close to the front side of the microwave oven.

13. The vent grille according to claim 12, wherein the grille main body and the guide rib are formed in one integral unitary piece.

14. The vent grille according to claim 2, wherein the guide member is an oblique guide surface formed by tapering a front wall of the grille main body toward the air outlet, the oblique guide surface being sloped from one of the top and bottom surfaces of the grille main body opposite to the air outlet toward the other of the top and bottom surfaces of the grille main body where the air outlet is disposed.

15. The vent grille according to claim 1, wherein the fixed front wall is non-movable with respect to the grille main body.

16. The vent grille according to claim 1, wherein the fixed front wall is substantially vertical when exhausting air out of the air outlet.

17. A vent grille comprising:
a grille main body locatable on a front side of a microwave oven, the grille main body having a fixed front wall free of any airflow openings;
an air path defined by the grille main body to allow airflow out of the microwave oven; and
the grille main body having at least one guide member configured to allow air to be discharged from the microwave oven through the air path in a forward direction from the microwave oven.

18. The vent grille according to claim 17, wherein the guide member guides air flowing in the air path away from the front side of the microwave oven in an upwardly or downwardly sloped direction.

19. The vent grille according to claim 17, wherein the guide member is disposed in the air path.

20. The vent grille according to claim 17, wherein after air and contaminants introduced into the microwave oven from food cooked on a cooking appliance disposed under the microwave oven are filtered to remove the contaminants from the air, the air is allowed to flow through the air path.

21. A microwave oven, comprising:
a body including a cooking chamber; and
a vent grille located on a front side of the body of the microwave oven, the vent grille including:
a grille main body, the grille main body having a fixed front wall free of any airflow openings; and
at least one air outlet disposed in a portion of the grille main body, the air outlet allowing airflow out of the microwave oven.

22. The microwave oven according to claim 21, wherein the fixed front wall is non-movable with respect to the grille main body, and is substantially vertical when exhausting air out of the air outlet.

23. The microwave oven according to claim 21, wherein the air hole outlet comprises:
at least one exhaust hole disposed in a portion of a top or bottom surface of the grille main body; and
an inlet hole disposed in another portion of the top or bottom surface of the grille main body close to the exhaust hole.
